(19) United States
(12) Patent Application Publication
(10) Pub. No.: US 2014/0069662 A1
(43) Pub. Date: Mar. 13, 2014

(54) EQUINE BONY COLUMN AND TISSUE SUPPORT WITH UNIFORM LOAD DISTRIBUTION TO ALL HOOF STRUCTURES AND A METHOD FOR USING THE SAME

(71) Applicant: DAVID ROBERT KORN, GRASS VALLEY, CA (US)

(72) Inventor: DAVID ROBERT KORN, GRASS VALLEY, CA (US)

(21) Appl. No.: 14/019,753

(22) Filed: Sep. 6, 2013

Related U.S. Application Data
(60) Provisional application No. 61/697,995, filed on Sep. 7, 2012.
(60) Provisional application No. 61/700,834, filed on Sep. 13, 2012.

(51) Int. Cl. A01L 3/00

(52) U.S. Cl. CPC A01L 3/00
USPC 168/26

(57) ABSTRACT

An equine bony column and tissue support is configured to prevent or treat lameness in a hoof of a horse where the lameness is based on a bony column dysfunction or instability. The equine bony column and tissue support includes a hoof bridge which includes a composition of matter with a hardness between Shore A Durometer of 85 and a Rockwell K of 150 bonded to the hoof. The composition of matter provides central loading support that redistributes weight from a perimeter of an outer hoof horn to the bony column and bony tissue to stabilize and realigns the bony column.

### RELATED APPLICATION

This application claims priority to provisional patent application U.S. Ser. No. 61/697,995 filed on Sep. 7, 2012 and U.S. Ser. No. 61/700,834 filed on Sep. 13, 2012, the entire contents of both applications are herein incorporated by reference.

### BACKGROUND

The embodiments herein relate generally to devices and processes that relate to equine hooves. The domesticate horse has many lameness issues relating to their hooves. These issues will impact their soundness, movement and performance. The horse can suffer from soft soles, medial and lateral imbalance, laminitis, tubular density, founder, navicular, sinking coffin bone, negative plane coffin bone, ring bone, side bone and shod to barefoot transitions. These issues can stem from the repetitive concussion of the hoof. As the hoof initiates contact with the ground elastic deformation begins to change the hoof in the shape and size due to an applied force. The elastic deformation energy is transferred through weight and movement of the horse. Compressive stresses are generated on the hoof tissue. Compressive stress will be applied to both external and internal structures. The ground will be applying forces upwards while the bony column and gravity will be all applying forces downwards. Compressive stress will be absorbed by the hoof bone and the specific hoof tissue structures in between. All of these structures have a yield point or yield strength. As used here, the yield strength or yield point of a material is as the stress at which a material begins to deform plastically, where plastically is the propensity of a material to undergo permanent deformation under load. Prior to the yield point, the hoof will deform elastically. When an applied stress is removed, the tissue returns to its original state. Once the yield point threshold is surpassed, some fraction of the deformation will be permanent and could be irreversible. As the horse approaches the yield point instability occurs prior to hoof failure. In particular, buckling is characterized by a sudden failure of structural hoof tissue subjected to high compressive stress where the actual compressive stress at the point of failure is less than the ultimate compressive stresses that the hoof structure is capable of withstanding.

During movement the horse reacts to input from its external environment. One such input is the vertical ground reaction force (GRF), which occurs during the ground contact phase of each foot. The impact forces that occur at heel strike of the hoof are transmitted to the foot structures both externally and internally. The repetitive mechanical loading creates mechanical waves. During ideal loading condition of the external structures of the foot, (frog, sole and horn are in contact with the ground) patterns of distribution of stimulus created by the mechanical wave. The initial energy input will travel through the structures until all the energy it transferred. This energy transfer consequence is stimulation. Stimulation is mandatory for optimal foot support, health, and function. Typically, these conditions do not exist for the domesticated horse to initiate this energy transferred progression. When the external foot components experience a decrease in ground contact, both external and internal failure commences.

To reverse the lack of ground contact with the structures on the bottom of the foot, a material with the characteristics of the bone must be applied to bottom of the foot to reestablish communication. This material will create pillars or the abutment in the collateral groove to supports the frog ligaments which allow the blood vessels to fill properly. The filling of the blood vessels act like an inner tube to support the hoof structures thus providing support to the ligaments.

The material applied to the hoof must replicate the bone in hardness and porosity. However, horseshoes create mechanical waves and frequencies dissimilar then bone waves and frequencies. The horseshoe applies its loading to the peripheral of the hoof capsule. The hoof capsule does not contain bone. In addition, the horseshoe frequencies produced during impact will hinder all blood vessel function for an extended period of time. Hence, lack of support to foot. The prior art includes: U.S. Patent Application 2010/0288515 issued to Rovelli; U.S. Pat. No. 6,021,851 along with U.S. Pat. No. 6,412,566 and U.S. Patent Application 2009/0173288 issued to Jacobs (collectively Jacobs);

Rovelli teaches using a pad between the horse shoe and the hoof to reduce shock. This creates a weight loading issue that can still result in lameness and is not likely or alleged to resolve existing lameness. Jacobs teaches a composition of matter that is too soft to have a therapeutic effect.

### SUMMARY

An equine bony column and tissue support is configured to prevent or treat lameness in a hoof of a horse where the lameness is based on a bony column dysfunction or instability. The equine bony column and tissue support includes a hoof bridge which includes a composition of matter with a hardness between Shore A Durometer of 85 and a Rockwell K of 150 bonded to the hoof. The composition of matter provides central loading support that redistributes weight from a perimeter of an outer hoof horn to the bony column and bony tissue to stabilize and realigns the bony column.

In some embodiments, the hoof bridge is applied evenly to a full application area. In other embodiments, the hoof bridge is applied in a stacked configuration at various thicknesses across a toe application area, a left quarter application area, a right quarter application area and a frog application area. The composition of matter can include a methacrylic acid, a methyl methacrylate monomer, a chlorosulfonated polyethylene and a carbon tetrachloride that is self-leveling.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of an embodiment of the invention.

FIG. 2 is a schematic view of the hoof anatomy.

FIG. 3 is a schematic view of a full application area.

FIG. 4 is a section view of the invention, taken along line 4-4 in FIG. 1

FIG. 5 is a perspective view of an embodiment of the invention

FIG. 6 is a schematic view of the partial application areas of the invention

FIG. 7 is a section view of an embodiment of the invention, taken along line 7-7 in FIG. 5

FIG. 8 is a chart showing the shore value range of the hoof bridge.

### DETAILED DESCRIPTION OF CERTAIN EMBODIMENTS

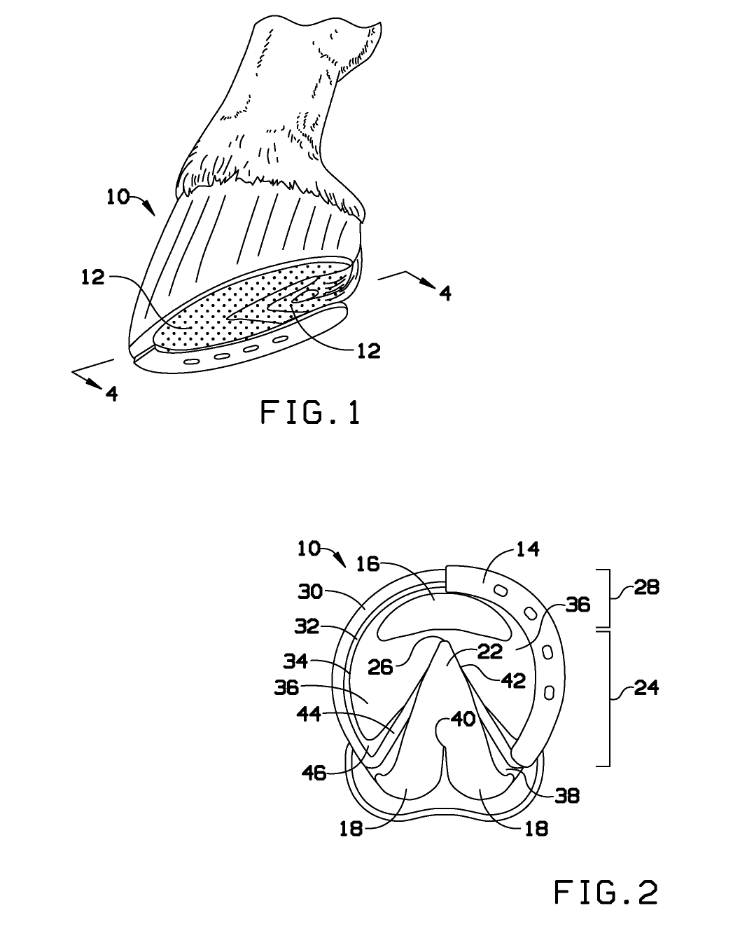

By way of example, and referring to FIG. 1, one embodiment of the present process comprises applying to horse 10 in need of such treatment a therapeutic amount of hoof bridge 12.

FIG. 2 shows a bottom view of horse hoof 10 shown with horse shoe 14 partially in place. Hoof 10 comprises toe callus 16 in toe 28 opposite heel bulbs 18. Heel bulbs is next to collateral groove 38 and extends forward past central sulcus 40 to frog 22 through quarter 24 comprising frog apex 26. Outer hoof horn 30 surrounds water line 32 which surrounds white line 34. Inside of white line 34 is sole 36 which extends to dirt line 42 that terminates at frog 22. Next to sole 36 is bar 44 and seat of corn 46.

FIG. 4 shows a section view of horse hoof 10. As noted above, frog 22 extends forward to sole 36. Above sole 36 is coffin bone 58 (sometimes called the distal phalanx) which is proximate navicular bone 60. Navicular bone 60 is proximate small pastern bone 62 (sometimes called the middle phalanx), which is below large pastern bone 64 (sometimes called the proximal phalanx). Collectively, coffin bone 58, small pastern bone 62 and large pastern bone 64 form the bony column. Adjacent to small pastern bone 62 and large pastern bone 64 is deep digital flexor tendon 66 which is partially surrounded by digital cushion 68. From the other side moving inward outer hoof wall 70 is next to a portion of laminae 76. Laminae 76 is next to sensitive laminae 72 and coronary band 74.

Turing to FIG. 4, the horse can have Navicular Disease as defined by The Merck Veterinary Manual Eight Edition “is essentially a chronic degenerative condition of the navicular bursa and navicular bone that involves damage to the flexor surface of the bone and the overlying deep digital flexor tendon 68 with osteophyte formation to the lateral and proximal boraders of the bone.” which can occur as the bony column 58, 62, 64 and tissue 22, 68 fail to provide structural support. The condition is treated by applying hoof bridge 12 to areas the heel and frog 56, left quarter 52 and right quarter 54. Once the hoof bridge 12 has set an internal wedge support can be stack over the heel and frog 56 to provide stability and internal support to the navicular bone 60 and its structure with out adversely impacting the bio mechanics of the hoof 10.

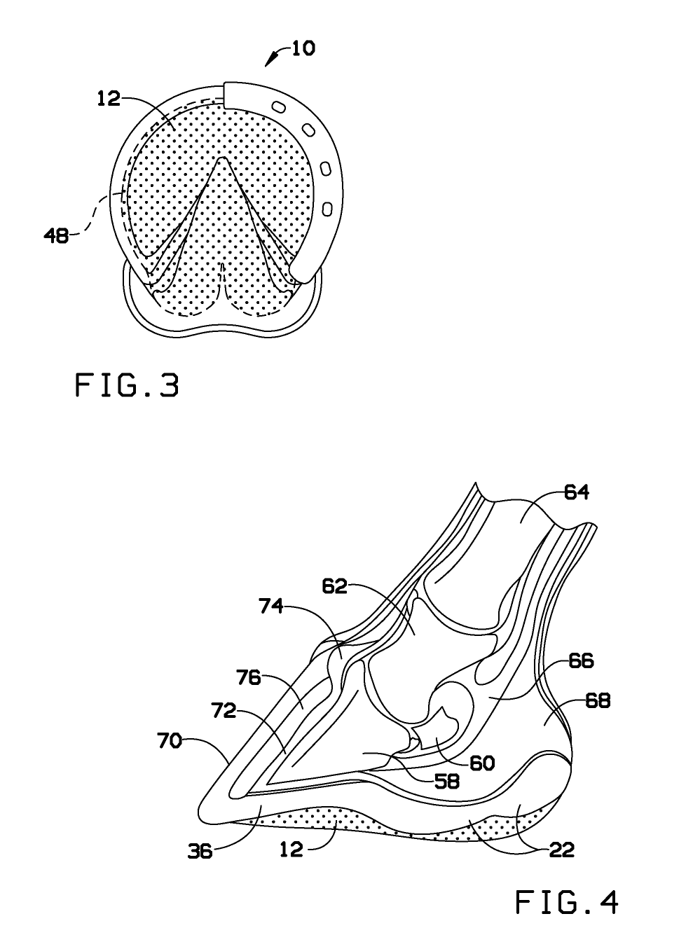

Turing to FIG. 3 and FIG. 4, the horse can suffer from laminitis, as defined by The Merck Veterinary Manual Eight Edition “as inflammation to the sensitive laminae of the hoof is thought to be transient ischemia associated with coagulopathy that leads to breakdown of degeneration of the union between the horny and sensitive laminae. In refractory cases, rotation of the coffin bone [58] is common sequela that may progress to perforation of the sole” which can occur when coffin bone 58 rotates downward towards the sole 36. This condition is treated by applying hoof bridge 12 to an application area such as full application area 48 on hoof 10. This regulates the equine bony column and tissue support.

Rovelli argued for using a rubber layer between horse shoe 14 and hoof 10, however that led to a number of problems. For instance, there was no uniform loading distribution. Rather, the loading was on the outer hoof horn. This could lead to mechanical laminitis by using dynamic loading to push outer hoof wall 70 from coffin bone 58.

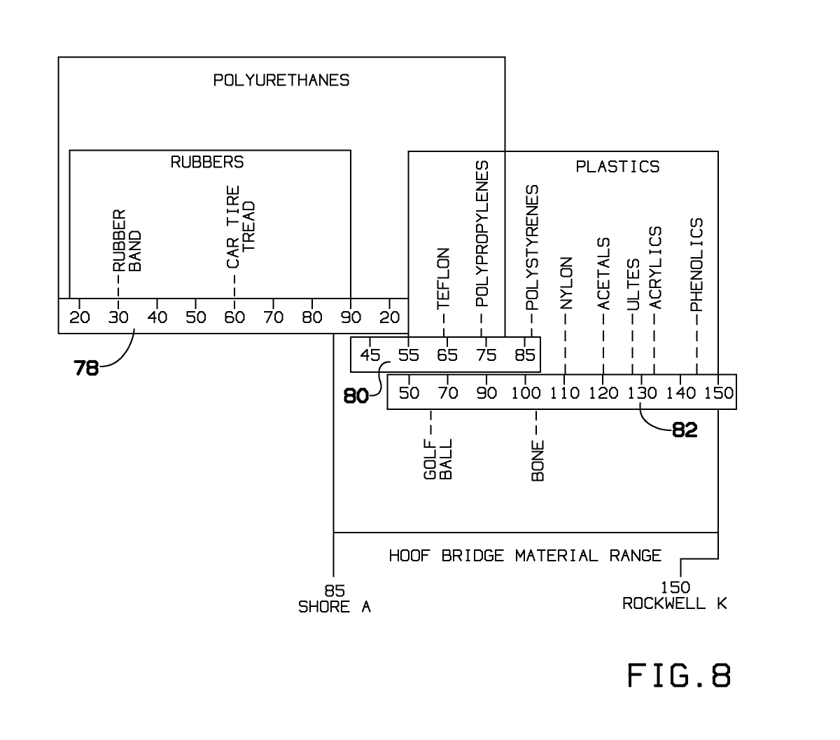

Hoof bridge 12 provides uniform load distribution (ULD) and structural support to the bony column and hoof structures by incorporating a non-deforming structural adhesive to produce superior strength and support greater than the present hoof tissues. A large spectrum of materials can accomplish this function as shown in FIG. 8. Any material with a Rockwell hardness of 85 to 150 that can be used in the manner described below can be used.

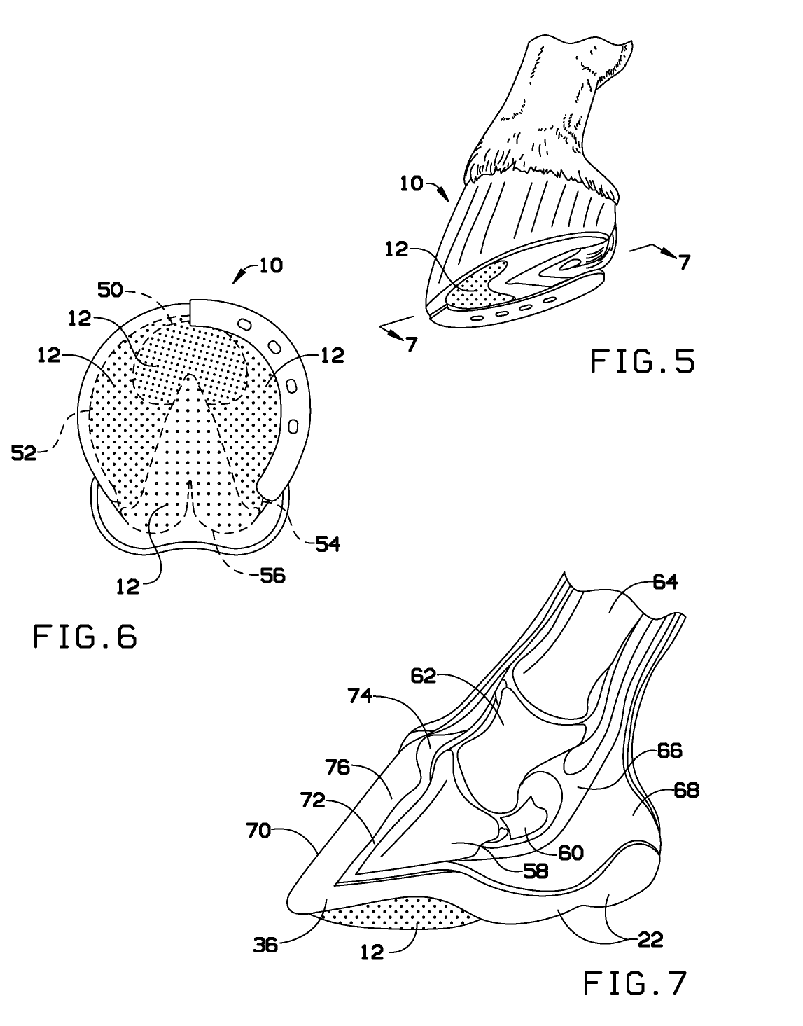

However, turning to FIG. 5, FIG. 6, and FIG. 7, depending on the horse's condition full application area 48 may not be appropriate. In some cases, having toe application area 50 at a different thickness than left quarter application area 52, right quarter application are 54 and frog application area 56 may be appropriately used in a stacked configuration.

By way of example, the rotation of coffin bone 58 away from hoof wall 70 puts an irregular strain on the union between the hoof wall 70 and the sensitive laminae 72. This can cause Ischemia-reperfusion injury by having too much or too little blood flow to laminae 74. Hoof bridge 12, resolves this problem by centrally loading external and internal hoof structures. In particular, hoof bridge 12 provides central loading support that redistributes the weight from the perimeter of the outer hoof horn 30 to the bony column 58, 62, 64 and the bony tissue 22, 36, 38, 68 to stabilize and realigns the bony column 58, 62, 64. This self-leveling composition of matter regulates blood profusion by realigning and replicating bone matter eliminating the irregular strain on outer hoof horn 30.

To use the invention, the user first performs an initial examination of hoof 10. The user should take a photograph to the condition of hoof 10. Next, the user documents physical dimensions of hoof 10. This can be useful in determining which hoof bridge 12 is necessary. The user then balances hoof 10 and prepares for application of hoof bridge 12. The user should obtain additional data on hardness and condition of the hoof as necessary.

After this, the user cleans and removes dirt and debris from hoof 10. The user then utilizes increased temperature to assist and reduce moisture content of the hoof. If necessary the user trims and cleans any bacteria tracks. The user can then preserves a sanitize environment and prepare to begin the process.

The user can then commence application of hoof bridge 12 to toe application area 50, left quarter application area 52, right quarter application area 54 and heel/frog application area 56 or any combination of. The user should mix thoroughly depending on bonding material or materials selected and the set time will be between 1-16 minutes. This includes applying hoof bridge 12 material to sole 36 by pushing both plungers on the cartridge evenly to dispense equal amounts of adhesive and activator. The user should start at apex of the frog 26 begin to outline coffin bone 58 with material. The user must complete mixing and spreading hoof bridge 12 within the set time after which point, hoof bridge 12 is bonded to hoof H. In some embodiments, it may be best to focus the application of the hoof bridge 12 material in the concavity of sole 36.

Turning to FIG. 8, hoof bridge 12 can be made from a variety of materials on Shore A Durometer 78, Shore D durometer 80 and Rockwell K 82 scale. However, the effective range of materials is from Shore A Durometer of 85 and a Rockwell K of 150. In this regard, the present invention teaches away from Jacobs which recommends “a low hardness of 40 to 80 Shore A to cushion the hoof.”

Of those materials, the following composition of matter is offered as one embodiment of an effective composition of matter. The composition of matter comprises 5-10% methacrylic acid by weight, 30-60% methyl methacrylate monomer by weight, 30-60% chlorosulfonated polyethylene by weight, and less than 1% carbon tetrachloride by weight. The composition of matter should be self-leveling.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An equine bony column and tissue support configured to prevent or treat lameness in a hoof of a horse, where the lameness is based on a bony column dysfunction or instability;
the equine bony column and tissue support comprising:
a hoof bridge comprising of a composition of matter with a hardness between Shore A Durometer of 85 and a Rockwell K of 150 bonded to the hoof;
wherein the composition of matter provides central loading support that redistributes weight from a perimeter of an outer hoof horn to the equine bony column and bony tissue to stabilize and realigns the equine bony column.

2. The equine bony column and tissue support of claim 1, wherein the hoof bridge is applied evenly to a full application area.

3. The equine bony column and tissue support of claim 1, wherein the hoof bridge is applied in a stacked configuration at various thicknesses across a toe application area, a left quarter application area, a right quarter application area and a frog application area.

4. The equine bony column and tissue support of claim 1, wherein the composition of matter comprises a methacrylic acid, a methyl methacrylate monomer, a chlorosulfonated polyethylene and a carbon tetrachloride that is self leveling.

5. A process for preventing or treating lameness and increasing performance in a horse that stabilizes, regulates and aligns an equine bony column by central loading external and internal hoof structures; the process comprising:
examining and photographing a hoof on the horse to determine how an internal wedge support would realign a bony column in the horse;
balancing the hoof and measuring a hardness of the hoof to determine the hardness of the internal wedge support;
cleaning an application area on the hoof; and
applying a hoof bridge to the hoof.

6. The process of claim 5, further comprising, utilizing plungers to evenly to dispense equal amounts of adhesive and activator on the application area creating the hoof bridge.

7. The process of claim 5, wherein the hoof bridge is applied evenly to a full application area.

8. The process of claim 5, wherein the hoof bridge is applied in a stacked configuration at various thicknesses across a toe application area, a left quarter application area, a right quarter application area and a frog application area.

9. The process of claim 5, wherein the hoof bridge comprises a methacrylic acid, a methyl methacrylate monomer, a chlorosulfonated polyethylene and a carbon tetrachloride that is self-leveling.
